(19) United States
(12) Patent Application Publication
(10) Pub. No.: US 2022/0205927 A1
(43) Pub. Date: Jun. 30, 2022

(54) ELECTRONIC LABEL INSPECTION DEVICE

(71) Applicant: Guangzhou Pulisi Technology Co., Ltd., Guangzhou (CN)

(72) Inventors: Xiaobo Lin, Guangzhou (CN); Lu Liu, Guangzhou (CN); Zhenhua Meng, Guangzhou (CN)

(21) Appl. No.: 17/530,525

(22) Filed: Nov. 19, 2021

(30) Foreign Application Priority Data
Dec. 29, 2020 (CN) 202023254286.6

(51) Int. Cl. G01N 21/89

(52) U.S. Cl. CPC G01N 21/8914

(57) ABSTRACT

The application relates to the field of inspection technologies, and discloses an electronic label inspection device, including a frame and a driving apparatus, an inspection apparatus, an unwinding apparatus, and a winding apparatus that are all disposed on the frame. The driving apparatus drives an electronic label tape to move from the unwinding apparatus to the winding apparatus to form a label tape path, the inspection apparatus includes a reading apparatus, the reading apparatus is disposed on the label tape path, and the reading apparatus is configured to read chip content of an electronic label. The application provides the electronic label inspection device to check whether a chip of an electronic label can be read normally, thereby implementing electronic label chip inspection.

### CROSS REFERENCE TO RELATED APPLICATIONS

The present application claims the benefit of Chinese Patent Application No. 202023254286.6 filed on Dec. 29, 2020, the contents of which are incorporated herein by reference in their entirety.

### TECHNICAL FIELD

The application relates to the field of inspection technologies, and in particular, to an electronic label inspection device.

### BACKGROUND

Before leaving factory, electronic labels are usually subjected to appearance inspection to eliminate unqualified products. However, the prior art only checks the appearance of the electronic labels, but does not check whether chips of the electronic labels can be read normally. Therefore, the electronic labels cannot be verified as qualified products when they leave factory.

### SUMMARY

The application aims to provide an electronic label inspection device, to check whether a chip of an electronic label can be read normally.

In order to achieve the above objective, the application provides an electronic label inspection device, including a frame and a driving apparatus, an inspection apparatus, an unwinding apparatus, and a winding apparatus that are all disposed on the frame, where the driving apparatus drives an electronic label tape to move from the unwinding apparatus to the winding apparatus to form a label tape path, the inspection apparatus includes a reading apparatus, the reading apparatus is disposed on the label tape path, and the reading apparatus is configured to read chip content of an electronic label.

Optionally, the inspection apparatus further includes an appearance inspection apparatus disposed on the frame, and an inspection position of the appearance inspection apparatus is disposed on the label tape path.

Optionally, the electronic label inspection device further includes a controller, and the controller is separately electrically connected to the reading apparatus, the driving apparatus, and the appearance inspection apparatus.

Optionally, the electronic label inspection device further includes a label removing apparatus disposed on the frame, the label removing apparatus is further disposed on the label tape path between the inspection apparatus and the winding apparatus, and the label removing apparatus is electrically connected to the controller.

Optionally, the electronic label inspection device further includes a label adding apparatus disposed on the frame, the label adding apparatus is further disposed on the label tape path between the label removing apparatus and the winding apparatus, and the label adding apparatus is electrically connected to the controller.

Optionally, the electronic label inspection device further includes a first correction apparatus disposed on the frame, and the first correction apparatus is further disposed on the label tape path between the label adding apparatus and the winding apparatus.

Optionally, the electronic label inspection device further includes a second correction apparatus disposed on the frame, and the second correction apparatus is disposed on the label tape path between the unwinding apparatus and the inspection apparatus.

Optionally, the driving apparatus includes a driving roller, and the driving roller drives the electronic label tape to move.

Optionally, the electronic label inspection device further includes a plurality of guide rollers, and the plurality of guide rollers are all disposed on the label tape path.

Optionally, the electronic label inspection device further includes an electrostatic eliminating apparatus disposed on the frame, and the electrostatic eliminating apparatus is configured to remove static electricity from the electronic label tape on the winding apparatus.

The application provides an electronic label inspection device, which has the following beneficial effects compared with the prior art:

The electronic label inspection device of the application includes a frame and a driving apparatus, an inspection apparatus, an unwinding apparatus, and a winding apparatus that are all disposed on the frame, where the driving apparatus drives an electronic label tape to move from the unwinding apparatus to the winding apparatus to form a label tape path, the inspection apparatus includes a reading apparatus, the reading apparatus is disposed on the label tape path, and the reading apparatus is configured to read chip content of an electronic label. The reading apparatus is provided to check whether a chip of an electronic label can be read normally. If the electronic label cannot be read normally by the reading apparatus, the electronic label is a defective label. If the electronic label can be read normally by the reading apparatus, the chip of the electronic label can operate normally. In this way, the electronic label chip inspection is implemented.

### BRIEF DESCRIPTION OF THE DRAWINGS

FIG. 1 is a schematic diagram illustrating a structure according to an embodiment of the application.

FIG. 2 is a schematic diagram of a label tape path according to an embodiment of the application.

In the figure, frame 1, driving roller 2, inspection apparatus 3, unwinding apparatus 4, winding apparatus 5, label tape path 6, controller 7, label removing apparatus 8, label adding apparatus 9, first correction apparatus 11, second correction apparatus 12, guide roller 13, reading apparatus 31, appearance inspection apparatus 32, label removing tape path 81, label adding tape path 91, driving apparatus 10, first label-removing driving assembly 82, second label-removing driving assembly 83, label-removing press block 84, label removing plate 85, label-removing unwinding assembly 86, label-removing winding assembly 87, label-adding unwinding assembly 92, label-adding winding assembly 93, label-adding driving assembly 94, label adding plate 95, and peeling end 951.

### DETAILED DESCRIPTION

The specific implementations of the application are described in more detail below with reference to the accompanying drawings and embodiments. The following embodiments are used to illustrate the application, but are not used to limit the scope of the application.

It should be understood that in the description of the application, terms such as “central”, “longitudinal”, “transverse” “upper”, “lower”, “front”, “rear”, “left”, “right” “vertical”, “horizontal”, “top”, “bottom”, “inside” and “outside” indicate the orientation or position relationships based on the drawings. They are merely intended to facilitate and simplify the description of the application, rather than to indicate or imply that the mentioned device or components must have a specific orientation or must be constructed and operated in a specific orientation. Therefore, these terms should not be construed as a limitation to the application. Moreover, the terms “first”, “second” and “third” are used only for the purpose of description, rather than to indicate or imply relative importance.

In the description of the application, it should be noted that, unless otherwise clearly specified, meanings of terms “install”, “connected with”, and “connected to” should be understood in a board sense. For example, the connection may be a fixed connection, a removable connection, or an integral connection; may be a mechanical connection or an electrical connection; may be a direct connection or an indirect connection by using an intermediate medium; or may be intercommunication between two components. A person of ordinary skill in the art may understand specific meanings of the foregoing terms in the application based on a specific situation.

In the description of the application, unless otherwise specified, “a plurality of” means at least two.

A person of ordinary skill in the art may understand specific meanings of the foregoing terms in the application based on a specific situation.

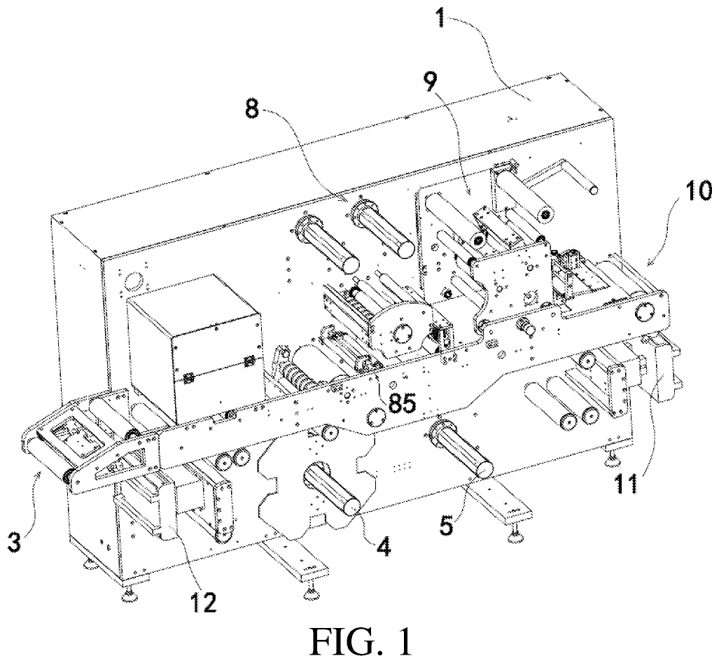

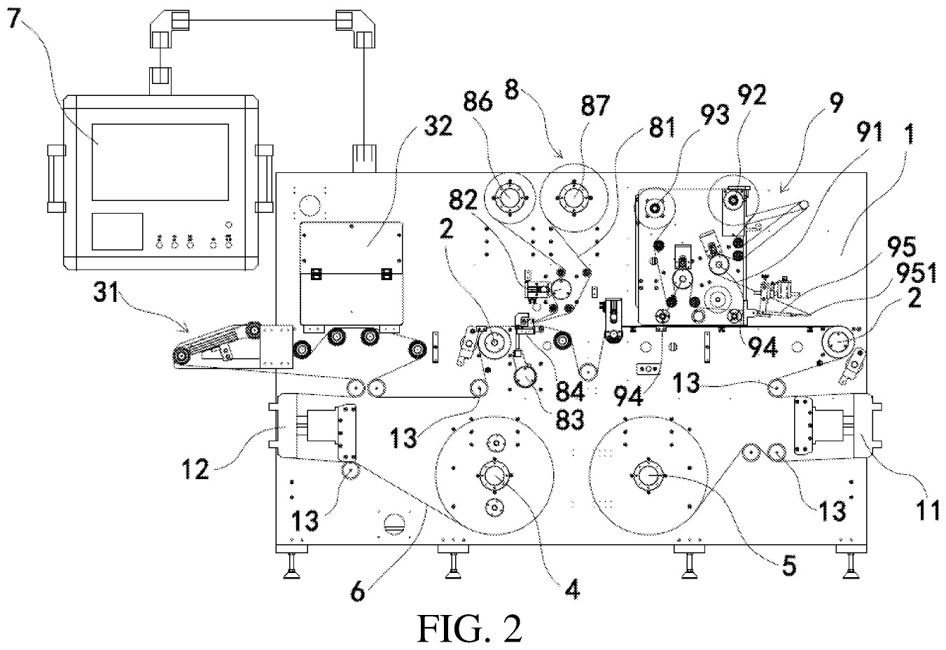

Referring to FIGS. 1 to 2, an electronic label inspection device in a preferred embodiment of the application includes a frame 1 and a driving apparatus 10, an inspection apparatus 3, an unwinding apparatus 4, and a winding apparatus 5 that are all disposed on the frame 1. The driving apparatus 10 drives an electronic label tape to move from the unwinding apparatus 4 to the winding apparatus 5 to form a label tape path 6. The inspection apparatus 3 includes a reading apparatus 31, the reading apparatus 31 is disposed on the label tape path 6, and the reading apparatus 31 is configured to read chip content of an electronic label. The driving apparatus 10 runs, the unwinding apparatus 4 unwinds the electronic label tape, the winding apparatus 5 winds the electronic label tape, and the electronic label tape moves along the label tape path 6. When the electronic label tape moves, it passes through the reading apparatus 31. The reading apparatus 31 checks whether a chip of the electronic label can be read normally. If the electronic label cannot be read normally by the reading apparatus 31, the electronic label is a defective label. If the electronic label can be read normally by the reading apparatus 31, the chip of the electronic label can operate normally. In this way, the electronic label chip inspection is implemented.

In this embodiment, the inspection apparatus 3 further includes an appearance inspection apparatus 32 disposed on the frame 1, and an inspection position of the appearance inspection apparatus 32 is disposed on label tape path 6. The appearance inspection apparatus 32 is a camera inspection apparatus that uses a camera to take an appearance picture of the electronic label and checks for a quality problem in the appearance of the electronic label. In this embodiment, the electronic label first passes through the reading apparatus 31 and then the appearance inspection apparatus 32. In other embodiments, the electronic label may first pass the appearance inspection apparatus 32 and then the reading apparatus 31.

The electronic label inspection device in this embodiment further includes a controller 7. The controller 7 is separately electrically connected to the reading apparatus 31, the driving apparatus 10, and the appearance inspection apparatus 32. The controller 7 can receive signals from the reading apparatus 31 and the appearance inspection apparatus 32, and can also send a signal to control the driving apparatus 10 to work. After the electronic label is inspected by the reading apparatus 31, if the electronic label cannot be read normally by the reading apparatus 31, the electronic label is a defective label; or if the electronic label can be read normally by the reading apparatus 31, the chip of the electronic label can operate normally. Then the electronic label is inspected by the appearance inspection apparatus 32. If the appearance inspection apparatus 32 detects an appearance quality problem on the electronic label, the electronic label is a defective label; or if the appearance inspection apparatus 32 detects no appearance quality problem on the electronic label, the electronic label is a qualified product.

In addition, the electronic label inspection device in this embodiment further includes a label removing apparatus 8 disposed on the frame 1. The label removing apparatus 8 is disposed on the label tape path 6 between the inspection apparatus 3 and the winding apparatus 5, and the label removing apparatus 8 is electrically connected to the controller 7. After a defective label is detected, the controller 7 controls the driving apparatus 10 to stop the electronic label at the label removing apparatus 8. After the label removing apparatus 8 removes the defective label, the electronic label tape continues to move. This embodiment describes an implementation of the label removing apparatus 8. The label removing apparatus 8 includes a first label-removing driving assembly 82, a second label-removing driving assembly 83, a label-removing press block 84, a label removing plate 85, a label-removing unwinding assembly 86, and a label-removing winding assembly 87. The first label-removing driving assembly 82 drives a label removing tape to move from the label-removing unwinding assembly 86 to the label-removing winding assembly 87 to form a label removing tape path 81. The label removing plate 85 is disposed on the label removing tape path 81, the label-removing press block 84 is disposed opposite the label removing plate 85, the label tape path 6 is located between the label-removing press block 84 and the label removing plate 85, the second label-removing driving assembly 83 is connected to the label-removing press block 84, and the controller 7 is separately electrically connected to the first label-removing driving assembly 82 and the second-label removing driving assembly 83. When the defective label arrives between the label removing plate 85 and the label-removing press block 84, the controller 7 controls the electronic label tape to stop moving, the controller 7 controls the second label-removing driving assembly 83 to drive the label-removing press block 84, and the label-removing press block 84 presses the electronic label tape containing the defective label to the label removing plate 85. The defective label comes into contact with the label removing tape on the label removing plate 85, and the defective label is thereby pasted on the label removing tape. The second label-removing driving assembly 83 drives the label-removing press block 84 to reset. The electronic label tape continues to move. The controller 7 further controls the first label-removing driving assembly 82 to drive the label removing tape to move, so that the subsequent label removing can be performed normally.

It should be noted that the electronic label inspection device further includes a label adding apparatus 9 disposed on the frame 1, the label adding apparatus 9 is disposed on the label tape path 6 between the label removing apparatus 8 and the winding apparatus 5, and the label adding apparatus 9 is electrically connected to the controller 7. After the defective label is removed by the label removing apparatus 8, there is a vacant position in the position of the defective label. The controller 7 controls the vacant position to stop at the label adding apparatus 9. After the label adding apparatus 9 adds a new electronic label, the electronic label tape continues to move. This embodiment describes an implementation of the label adding apparatus 9. The label adding apparatus 9 includes a label-adding unwinding assembly 92, a label-adding winding assembly 93, a label-adding driving assembly 94, and a label-adding plate 95. The label-adding driving assembly 94 drives a label adding tape to move from the label-adding unwinding assembly 92 to the label-adding winding assembly 93 to form a label adding tape path 91. The label adding plate 95 has a peeling end 951 configured to peel off a label on the label adding tape. The peeling end 951 is disposed on the label adding tape path 91. The controller 7 is electrically connected to the label-adding driving assembly 94. The label-adding unwinding assembly 92 is configured to unwind the label adding tape, and the label adding plate 95 lifts the electronic label on the label adding tape and separates it from the label adding tape to realize the label adding. When the vacant position reaches the label adding apparatus 9, the controller 7 controls the driving apparatus 10 to stop working, and the electronic label tape stops moving. The controller 7 also controls the label-adding driving assembly to add an electronic label to the vacant position.

In this embodiment, the electronic label inspection device further includes a first correction apparatus 11 disposed on the frame 1, and the first correction apparatus 11 is disposed on the label tape path 6 between the label adding apparatus 9 and the winding apparatus 5. Before the electronic label tape is inspected by the inspection apparatus 3, the electronic label tape is corrected to ensure that the inspection can be performed normally. The electronic label inspection device further includes a second correction apparatus 12 disposed on the frame 1, and the second correction apparatus 12 is disposed on the label tape path 6 between the label unwinding apparatus 4 and the inspection apparatus 3. After label adding, followed by correction by the second correction apparatus 12, the electronic label tape can be neatly wound on the winding apparatus 5.

The driving apparatus 10 in this embodiment includes a driving roller 2, and the driving roller 2 drives the electronic label tape to move. In this embodiment, two driving rollers 2 are disposed, one is disposed on the label tape path 6 between the appearance inspection apparatus 32 and the label removing apparatus 8, and the other is disposed on the label tape path 6 between the label adding apparatus 9 and the second correction apparatus 12. The electronic label inspection device in this embodiment further includes a plurality of guide rollers 13, and the plurality of guide rollers 13 are all disposed on the label tape path 6. The guide rollers 13 ensure that the electronic label tape can move along the label tape path 6.

It should be noted that, the electronic label inspection device in this embodiment further includes an electrostatic eliminating apparatus disposed on the frame 1, and the electrostatic eliminating apparatus is configured to remove static electricity from the electronic label tape on the winding apparatus 5. The electrostatic eliminating apparatus in this embodiment includes a plurality of electrostatic ropes, one end of the plurality of electrostatic ropes is in contact with the electronic label tape on the winding apparatus 5, and the other end is connected to a ground cable. With such arrangement, static electricity on the electronic label tape on the winding apparatus 5 can be transferred to the ground through the electrostatic ropes, so as to eliminate the static electricity.

In summary, the application provides an electronic label inspection device, to check whether a chip of an electronic label can be read normally, thereby implementing electronic label chip inspection.

The above descriptions are merely preferred implementations of the application. It should be noted that a person of ordinary skill in the art may further make several improvements and modifications without departing from the principle of the application, but such improvements and modifications should be deemed as falling within the protection scope of the application.

1. An electronic label inspection device, comprising a frame, and a driving apparatus, an inspection apparatus, an unwinding apparatus, and a winding apparatus that are all disposed on the frame, wherein the driving apparatus drives an electronic label tape to move from the unwinding apparatus to the winding apparatus to form a label tape path, the inspection apparatus comprises a reading apparatus, the reading apparatus is disposed on the label tape path, and the reading apparatus is configured to read chip content of an electronic label.

2. The electronic label inspection device according to claim 1, wherein the inspection apparatus further comprises an appearance inspection apparatus disposed on the frame, and an inspection position of the appearance inspection apparatus is disposed on the label tape path.

3. The electronic label inspection device according to claim 2, further comprising a controller, wherein the controller is separately electrically connected to the reading apparatus, the driving apparatus, and the appearance inspection apparatus.

4. The electronic label inspection device according to claim 3, further comprising a label removing apparatus disposed on the frame, wherein the label removing apparatus is disposed on the label tape path between the inspection apparatus and the winding apparatus, and the label removing apparatus is electrically connected to the controller.

5. The electronic label inspection device according to claim 4, further comprising a label adding apparatus disposed on the frame, wherein the label adding apparatus is disposed on the label tape path between the label removing apparatus and the winding apparatus, and the label adding apparatus is electrically connected to the controller.

6. The electronic label inspection device according to claim 5, further comprising a first correction apparatus disposed on the frame, wherein the first correction apparatus is disposed on the label tape path between the label adding apparatus and the winding apparatus.

7. The electronic label inspection device according to claim 1, further comprising a second correction apparatus disposed on the frame, wherein the second correction apparatus is disposed on the label tape path between the unwinding apparatus and the inspection apparatus.

8. The electronic label inspection device according to claim 1, wherein the driving apparatus comprises a driving roller, and the driving roller drives the electronic label tape to move.

9. The electronic label inspection device according to claim 1, further comprising a plurality of guide rollers, wherein the plurality of guide rollers are all disposed on the label tape path.

10. The electronic label inspection device according to claim 1, further comprising a electrostatic eliminating apparatus disposed on the frame, wherein the electrostatic eliminating apparatus is configured to eliminate static electricity from the electronic label tape on the winding apparatus.
